(19) United States
(12) Patent Application Publication
(10) Pub. No.: US 2008/0218347 A1
(43) Pub. Date: Sep. 11, 2008

(54) SECURING METHOD AND MOBILE DEVICE THUS SECURED

(75) Inventor: David Naccache, Paris (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Compagnie Industrielle Et Financiere D'Ingenierie "Ingenico", Neuilly Sur Seine (FR)

(21) Appl. No.: 12/041,267

(22) Filed: Mar. 3, 2008

(30) Foreign Application Priority Data
Mar. 2, 2007 (FR) 0701539

(51) Int. Cl. G08B 13/14

(52) U.S. Cl. 340/572.1

(57) ABSTRACT

A method and apparatus are provided for securing a mobile digital processing device. The method includes: a protective step that is self-activated when the mobile device measures an evolutionary value approaching a threshold value and wherein the mobile device executes a protective action; and includes a step of self-setting the evolutionary value when the mobile device and a holder associated therewith are detected in a common vicinity. The evolutionary value is positioned at a value remote from the threshold value, so as to allow the evolutionary value to approach the threshold value naturally, when the mobile device and the holder are no longer detected in a common vicinity.

### CROSS-REFERENCE TO RELATED APPLICATIONS

None.

### FIELD OF THE DISCLOSURE

This disclosure relates to a method for securing a mobile device, a mobile digital processing device thus secured and a holder for a particular mobile device.

### BACKGROUND OF THE DISCLOSURE

Mobile digital processing devices such as mobile telephones, handheld payment terminals or personal assistants offer a high degree of versatility because of the mobility thereof, which is offset, however, by a certain degree of susceptibility to theft or loss. This susceptibility is particularly critical when the mobile device contains sensitive data which enables fraudulent use thereof by a malicious person in possession of the mobile device.

Combating the theft or loss of mobile devices has been the subject of many research projects and studies, which have resulted in certain solutions.

The document FR2855895 proposes a method in which the user of a radio communication device calls his device and transmits a code, the effect of which is to prevent the use of the device or to warn a third party of the status of the missing device. The necessary involvement of the user can have disadvantages in some cases, for example, such as those wherein, for one reason or another, the user is not aware of the loss or theft of his device or is unable to call his device, either because he does not have any equipment within his reach to do so, or because he is physically prevented from doing so.

The document FR2836616 proposes a method similar to the previous one in that it consists in sending a text or SMS message to one's mobile telephone. This message contains parameters identical to control parameters pre-recorded by the user. For example, an access control parameter is a date which determines a service life at the end of which the wireless telephone is automatically blocked. It is again noted here that the user is heavily involved in order to program their parameters and manage them by communicating with their mobile device.

### SUMMARY

An aspect of the present disclosure is directed to a method for securing a mobile digital processing device comprising:
a protective step that is self-activated when the mobile device measures an evolutionary value approaching a threshold value and wherein the mobile device executes a protective action
a step of self-setting said evolutionary value when the mobile device and a holder associated therewith are detected in a common vicinity and wherein said evolutionary value is positioned at a value remote from said threshold value, so as to allow said evolutionary value to approach said threshold value naturally, when the mobile device and said holder are no longer detected in a common vicinity.

An aspect of the present disclosure also proposes a mobile digital processing device and a mobile device holder, respectively, comprising protective means and recognition means designed to execute the steps of the method and short-range data transmission means, respectively, more particularly a radio frequency identification tag (RFID), which identifies the holder.

According to one or more exemplary and non-limiting embodiments, the method includes one or more of the following features: the protective action includes destroying private user data residing within the mobile device, sending out an alarm that can be detected by a human sense and/or sending a message to a pre-established or user-selected recipient. The evolutionary value is primarily temporal in nature for example.

### BRIEF DESCRIPTION OF THE DRAWINGS

Other features and advantages will become apparent upon reading the following description of a non-limiting example, given for illustrative purposes and in reference to the appended drawings in which:

FIG. 1 is a schematic representation of a system according to an exemplary aspect of the present disclosure;

FIG. 2 is a schematic representation of mobile device according to an exemplary aspect of the present disclosure; and

FIG. 3 is a schematic representation of the steps of the method according to an exemplary aspect of the present disclosure.

### DETAILED DESCRIPTION OF ILLUSTRATIVE EMBODIMENTS

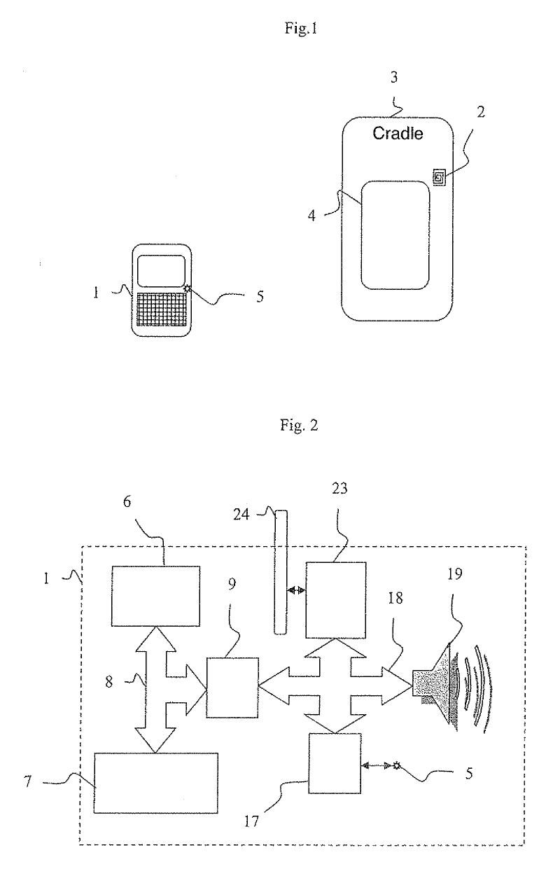

For illustrative non-limiting purposes, FIG. 1 is a schematic representation of a mobile digital processing device 1, such as a mobile telephone, a handheld payment terminal or a pocket personal computer. A base-type holder 3 is associated with this mobile device. This consists of a cradle, for example, into which the mobile device is put back regularly in order to recharge the batteries thereof, in order to connect it to a particular system via wired communication means, or to simply store it.

The holder 3 includes a beacon 2 consisting of, for example, a passive transponder portion such as a radio frequency identification tag (RFID). These types of tags are often recognized by the visible portion thereof, which resembles a small labyrinth and which is actually the antenna at the centre of which is situated a chip containing specific data. One advantage is that this type of tag, like generally any passive transponder portion, consists of a short-range transmission means which does not require a power source of its own in order to transmit the data that it contains. It is the active portion of the transponder, e.g., an RFID tag reader 5, which supplies the power required for the data transmission process via the passive portion.

This type of process is well known, but the fundamentals thereof can be quickly recalled with the aid of FIG. 3. The beacon 2, in this case the RFID tag, is most often powered off during an initial step 20. A request signal at the appropriate frequency then supplies sufficient voltage to the RFID tag to validate a transition 21, which thereby switches the tag from step 20 to step 22. The voltage generated by the request signal is generally sufficient for the tag at step 22 to control the request, if necessary, and to transmit one or more data items from the memory thereof prior to returning to step 20. If the response being provided at step 22 contains more data than can be transmitted by it in one cycle, then the request is in the form of a signal burst which, upon each return to step 20, again validates the transition 21 so as to successively read all of the data. As will be seen in the continuation of the description, the data being transmitted by the beacon 2 identifies the holder.

The mobile device 1 is equipped with the reader 5, which automatically reads the contents of the beacon 2 when it is brought close to the holder 3. It is possible, on the one hand, to dispose the reader 5 on the mobile device and, on the other hand, the beacon 2 on the holder, so as to require the mobile device 1 to actually be stored in the cradle of the holder in order to bring the reader and the beacon suitably close together. The beacon contains data which specifically identifies and associates the holder with the mobile device. This data, for example, includes an encrypted code. It is also possible to anticipate inlaying, or even embedding, the beacon into the material comprising the holder 3, so that any attempt to tear off the tag in order to transfer it onto another holder, results in the beacon being placed out of service.

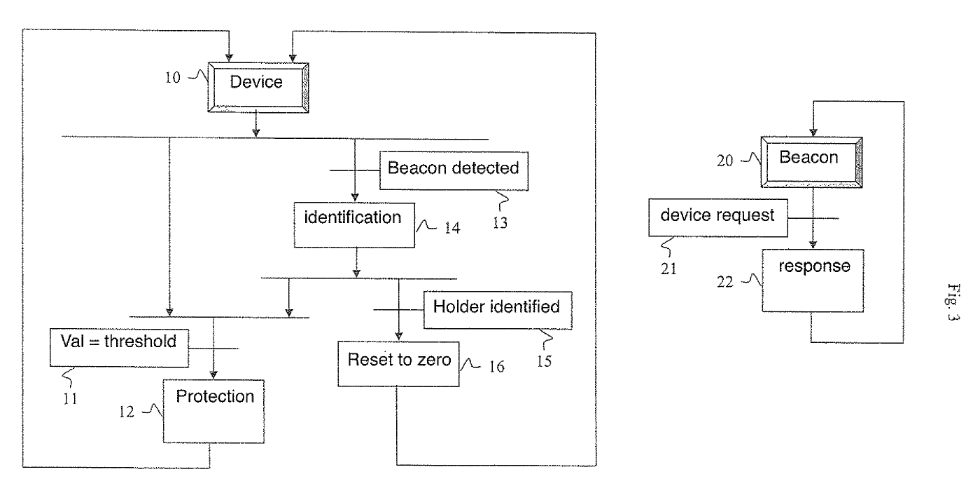

In reference to FIG. 2, the mobile device includes a microprocessor 6, a memory 7 and an input-output interface 9, connected together via a system bus 8. An input-output bus 18 connects the interface 9 to a reader coupler 17 designed to read information coming from the beacon 2 by means of the reader 7, more particularly of the radio frequency identification tag reader type. Other peripherals are generally connected to the bus 18, e.g., such as a sound card speaker assembly 19, a vibrator, a flashing light-emitting diode or any other alarm-sounding means detectable by a human sense. When the mobile device is a remote communication device, a coupler 23 is connected to the bus 18, on the one hand, and to a radio antenna 24, on the other hand, in order to transmit and receive messages processed by the processor 6.

By its nature, the memory 7 is considered to be as extended as possible; it can include a RAM volatile memory or the like, or permanent memory residing on a disk or on a microprocessor card. The memory 7 contains private user data which, for example, consists of subscription references for a mobile telephone, bank references for a payment terminal and possibly other data for which access or use by persons other than the user might be harmful to the user. For example, this may involve a list of contacts or personal files.

In the example presented herein, protective means are designed as follows.

A first digital word of the counter type 7 located in memory or directly inside a memory cell of the coupler 17, is intended to contain an evolutionary value. The evolution of this value is the result of a periodic measurement taken by the processor 6.

To illustrate, it is known that the operation of a digital processing device is generally synchronized by a system clock. A memory program 7 designed in combination with the processor 6, in order to tally clock pulses, consists of clock means which generates a temporal evolutionary value. Comparable to a time period, the evolutionary value is therefore increasing.

To illustrate further, it is known that the operation of a digital processing device generally consumes power supplied by a battery. A memory program 7 designed in combination with the processor 6, in order to periodically record the battery level and transfer it into the first digital word, consisting of means other than clock means, which generate an evolutionary value having a nature other than a temporal nature. Since consumption causes depletion of the battery, the evolutionary value is therefore diminishing.

A second digital word of a constant or parameterable nature is intended to contain a threshold value. The threshold value, as will be seen hereinbelow, is typically greater than a value to which the first digital word is initialized when the evolutionary value is increasing. The threshold value, as will be seen hereinbelow, is typically lower than a value to which the first digital word is initialized when the evolutionary value is diminishing. The choice of the threshold value is determined so as to enable the value of the first digital word to evolve in the direction of approaching the threshold value, prior to triggering a protective action.

The memory program 7 includes logic instructions for comparing the first and the second digital word and for executing a protective action when the contents of the two digital words are equal.

At a first stage, the logic instructions for executing a protective action include, for example, instructions for sounding an alarm detectable by human sense. As a matter of fact, the danger of a fraudulent use of the mobile device is less if the device is simply misplaced in one room or another of a flat. If the human sense is hearing, a bell, or if the human sense is seeing, a succession of flashes, e.g., to prevent disturbing a sleeping child, therefore comprises a means of enabling the mobile device to be recovered by the user thereof.

At a second stage, the logic instructions for executing a protective action include, for example, instructions for generating a message and operating the coupler 23 so as to send the message to a designated recipient by means of the antenna 24. The coordinates and possibly spoken or written content are stored in an area of the memory 7 provided for that purpose. The recipient can be pre-established, as is the case of a telephone operator or banking agent, in order to cancel a subscription or debit, respectively, prior to recovering the mobile device. The recipient can also be chosen by the user, e.g., such as the user themselves, on another telephone, in order to remind themselves to take care of their mobile device.

At a third stage, and regardless of the existence or non-existence of the previously mentioned instructions, the logic instructions for executing a protective action include, for example, instructions for deleting all or a portion of the private, confidential or encrypted data in memory 7 or in any other location within the mobile device 1. This prevents fraudulent use of the mobile device by a thief.

In the example presented herein, recognition means are designed as follows.

The coupler 17 is designed to detect the proximity of the holder 3 when the reader 5 transmitting a continuous radio listening signal receives a response from the beacon 2.

A third identifier-type digital word located in memory 7 or directly inside a memory cell of the coupler 17, is intended to contain a value enabling recognition that the beacon 2 is that of the holder 3 associated with the mobile device 1. For example, this simply consists of an alphanumeric string corresponding to an identical alphanumeric string that is stored in beacon 2. At a more advanced level, for example, this further consists of a public key, the private key of which is concealed inside the beacon 2, so as to carry out challenge-response identification.

The memory 7 contains one or more sequences of logic instructions set up so as to identify the beacon and, in the event of a valid identification, in order to initialize the first digital word by positioning the evolutionary value at a value greater or lesser than that contained in the second memory word, in the event of a diminishing or increasing evolutionary value, respectively, so as to allow the evolutionary value to approach said threshold value naturally, when the holder is no longer detected as being within proximity to the mobile device.

The operation of the aforesaid technical means will now be explained in greater detail, in reference to FIG. 3.

A method for securing a mobile digital processing device in accordance with an example of the present disclosure includes a protective step 12 that is self-activated when a transition 11 is valid.

Since the mobile device is initially in a standby step 10, the transition 11 is validated when Val=threshold. Val is typically the evolutionary value measured by the mobile device discussed earlier in the description. In step 10, the mobile device is not necessarily inactive and may execute actions other than those of the method. Particularly when the evolutionary value is of a temporal nature, the equality of the transition 11 is actually verified when the mobile device has remained distant from the holder thereof for a period of time sufficiently long enough to evolve the evolutionary value in the direction of approaching the threshold value at the point of attaining it. This may occur, for example, when the mobile device, which had been stolen or lost separately from the holder thereof, was not returned thereto within a predetermined time period.

The protective action executed in step 12 is unique and irreversible or differentiated and gradual. The irreversible action is typically that which consists in destroying private user data residing in the mobile device. This prevents the mobile device from being compromised when it is stolen, unless the thief steals the holder also.

A less violent action consists in sounding an alarm that can be detected by a human sense which, if uncovered by the legitimate user (simple loss or misplacement), enables them to take better care of their mobile device by returning it to the holder thereof, for example. The protective action, which consists in sending a message to a recipient pre-established or chosen by the user, enables the mobile device to be re-used when recovered, while being careful to carry out some verification operations, if necessary.

A method for securing a mobile digital processing device in accordance with an example of the present disclosure includes a step of self-setting (16) said evolutionary value when a transition 15 is validated.

The transition 15 is validated when, having brought the mobile device closer to a holder, the holder is identified by the mobile device as being the holder associated with the mobile device.

In step 16, the evolutionary value is set at a value distant from the threshold value, so as to allow said evolutionary value to approach said threshold value naturally, when the mobile device and said holder are not detected in a common vicinity. When the evolutionary value is of a temporal nature, it is reset to zero, the threshold value then corresponding to the time period at the end of which there is reason to worry if the terminal has not been returned to the holder thereof.

The advantage of the method can be appreciated for the user who has no other concern but that of regularly storing the mobile device on the holder thereof, which is rather normal even if only to recharge the mobile device. All of the actions are then carried out automatically, without having any need of the user, particularly when the user is unavailable for one reason or another.

Step 16 is generally preceded by a step 14, which is activated when the mobile device is in step 10 and a transition 13 is validated.

The transition 13 is validated when the beacon 2 is detected by the reader 5.

Step 14 serves to verify that the holder detected in a vicinity common to the mobile device is indeed the holder associated therewith. To do so, the mobile device initiates a beacon 2 identification procedure which, in the simplest form thereof, might consist in reading an alphanumeric string contained inside the beacon 2 and in comparing it to the equivalent thereof contained within the mobile device. It is understood that this way of operating is not the most secure. An intruder would need only to read this alphanumeric string and to copy it on another beacon in order to manufacture fake holders. In one preferred embodiment, the beacon conceals a private key the corresponding public key of which is held by the mobile device. The mobile device 1 generates a random number that it encrypts with the private key before sending it to the beacon 2. The beacon sends back the number after having encrypted it with its private key. If the number received by the mobile device is the random number generated prior to being encrypted by the public key, the mobile device is confirmed in the identification, because only the beacon associated with the mobile device possesses the private key.

A tamperproof beacon on the holder for the mobile device has the additional technical effect of preventing illegitimate copies of the holder from being made.

An aspect of the present disclosure provides a securing method and a mobile digital processing device thus secured, which at least partially mitigates the aforesaid disadvantages of the prior art.

More particularly, an aspect of the present disclosure provides a method, which triggers a protective action for the mobile device without requiring the legitimate user to intervene in order to initiate the protective action.

More precisely, an aspect of the present disclosure provides a fail-safe method, i.e., with default triggering of the protective action.

A further aspect of the present disclosure provides a securing method, which makes life as easy as possible for the legitimate user in the event of fraudulent appropriation of the mobile device.

This invention recited in the appended claims is quite obviously not limited to the examples and embodiment described and shown, but is susceptible of numerous alternatives attainable by a person skilled in the art. Although the present disclosure has been described with reference to one or more examples, workers skilled in the art will recognize that changes may be made in form and detail without departing from the scope of the disclosure and/or the appended claims.

What is claimed is:

1. Method for securing a mobile digital processing device comprising:
a protective step that is self-activated when the mobile device measures an evolutionary value approaching a threshold value and wherein the mobile device executes a protective action; and
a step of self-setting said evolutionary value when the mobile device and a holder associated therewith are detected in a common vicinity and wherein said evolutionary value is positioned at a value remote from said threshold value, so as to allow said evolutionary value to approach said threshold value naturally, when the mobile device and said holder are no longer detected in a common vicinity.

2. Method of securing a mobile device of claim 1, wherein the protective action comprises destroying private user data residing within the mobile device.

3. Method of securing a mobile device of claim 1, wherein the protective action comprises sounding an alarm that can be detected by a human sense.

4. Method of securing a mobile device of claim 1, wherein the protective action comprises sending a message to a recipient pre-established or chosen by the user.

5. Method of securing a mobile device of claim 1, wherein said evolutionary threshold value is temporal by nature.

6. Mobile digital processing device comprising:
protective means (6, 7) designed to measure an evolutionary value in the direction of approaching a threshold value, in order to detect attainment of said threshold value by said evolutionary value and to execute a protective action when said threshold value is attained; and
means of recognizing a holder associated with the mobile device, designed to detect proximity of said holder and to position said evolutionary value at a value remote from said threshold value, so as to allow said evolutionary value to approach said threshold value naturally, when said holder is no longer detected within proximity to the mobile device.

7. Mobile digital processing device of claim 6, wherein the device includes means of destroying private user data residing within the mobile device, in order to execute said protective action.

8. Mobile digital processing device of claim 6, wherein the device includes means for sounding an alarm that can be detected by a human sense, in order to execute said protective action.

9. Mobile digital processing device of claim 6, wherein the device includes means designed to send a message to a recipient pre-established or chosen by the user, in order to execute said protective action.

10. Mobile digital processing device of claim 6, wherein the device includes clock means designed to generate the evolutionary value of a temporal nature.

11. Mobile digital processing device of claim 6, wherein said means of recognizing include a radio frequency identification tag reader.

12. Mobile digital processing device holder comprising short-range data transmission means which identify the holder.

13. Mobile digital processing device holder of claim 12, wherein said short-range transmission means include a radio frequency identification tag.
